(19) United States
(12) Patent Application Publication
(10) Pub. No.: US 2023/0246502 A1
(43) Pub. Date: Aug. 3, 2023

(54) ASSEMBLY FOR AN ELECTRIC MACHINE

(71) Applicant: MAHLE International GmbH, Stuttgart (DE)

(72) Inventor: Patrick Altherr, Stuttgart (DE)

(21) Appl. No.: 18/105,237

(22) Filed: Feb. 2, 2023

(30) Foreign Application Priority Data
Feb. 3, 2022 (DE) 10 2022 201 139.2

(51) Int. Cl. H02K 1/32; H02K 9/19; B60K 1/00

(52) U.S. Cl. CPC H02K 1/32; H02K 9/19; B60K 1/00; B60K 2001/006

(57) ABSTRACT

An assembly for an electric machine may include a rotor shaft and a temperature sensor. The rotor shaft may rotate about an axial rotation axis and/or the rotor shaft may include a wall extending in a circumferential direction and axially. In an interior of the rotor shaft, the wall may radially delimit a hollow space. The temperature sensor may be attached radially inside the wall. The rotor shaft may further include a first axial end face, a second axial end face located opposite the first axial end face, an inlet opening for admitting a cooling fluid into the hollow space, and at least one outlet opening for discharging the cooling fluid out of the hollow space. The cooling fluid may flow along the temperature sensor.

### CROSS-REFERENCE TO RELATED APPLICATIONS

This application claims priority to German Patent Application No. DE 10 2022 201 139.2, filed on Feb. 3, 2022, the contents of which is hereby incorporated by reference in its entirety.

### TECHNICAL FIELD

The present invention relates to an assembly for an electric machine, wherein the assembly includes a rotor shaft. Further, the invention relates to a system having an assembly and to an electric machine as well as to a motor vehicle having such a system.

### BACKGROUND

An electric machine comprises a stator and a rotor, which interact during the operation, so that the rotor rotates about a rotation axis. The rotor usually includes a rotor shaft. During the operation of the electric machine heat is generated, in particular with increasing power. Cooling of the electric machine allows operating the electric machine with increased power and/or protecting parts of the electric machine. The cooling of the electric machine generally leads to energy consumption, so that the total efficiency is reduced, and/or in an associated application, the energy that is available for operating the electric machine is reduced.

### SUMMARY

The present invention therefore deals with the object of stating, for an assembly having a rotor shaft of the type mentioned at the outset, for a system having an electric machine and such an assembly as well as for a motor vehicle having such a system, improved or at least other embodiments which eliminate in particular disadvantages from the prior art. In particular, the present invention deals with the object of stating, for the assembly and for the system and for the motor vehicle, improved or at least other embodiments which are characterised by an increased efficiency.

According to the invention, this object is solved through the subjects of the independent claim(s). Advantageous embodiments are the subject matter of the dependent claim(s).

Accordingly, the present invention is based on the general idea of cooling a rotor shaft by introducing a cooling fluid into the interior of the rotor shaft and arranging a temperature sensor in the interior of the rotor shaft, which allows feeding the cooling fluid into the rotor shaft to suit requirement. The arrangement of the temperature sensor in the interior of the rotor shaft allows a reliable determination of temperatures that are important for the operation, namely of the cooling fluid and/or rotor shaft, so that as a consequence the necessary feeding of the cooling fluid into the rotor shaft can be more accurately adjusted to suit requirement. By feeding the cooling fluid to suit requirement, a reduction of the energy needed for the feeding takes place, which leads to an increase of the efficiency. In addition, the idea according to the invention utilises the knowledge that, due to the mass and/or inertia of the cooling fluid, the cooling fluid introduced into the interior of the rotor shaft leads to the absorption of rotation energy, which is again lost upon the discharge of the cooling fluid. Introducing the cooling fluid into the rotor shaft to suit requirement reduces the losses by way of the said rotation energy, so that in turn the efficiency during the operation of the rotor shaft is increased.

According to the inventive idea, an assembly includes the rotor shaft and the temperature sensor. During the operation, the rotor shaft rotates about an axial rotation axis. The rotor shaft comprises a wall extending in a circumferential direction and axially, which in the interior of the rotor shaft radially delimits a hollow space. In addition, the rotor shaft comprises two axially opposite end faces, which in the following are also referred to as first axial end face and second axial end face. The rotor shaft comprises an inlet opening for admitting the cooling fluid into the hollow space and at least one outlet opening for discharging the cooling fluid out of the hollow space, through which a flow path of the cooling fluid leads. The temperature sensor is attached to the wall radially inside, so that the cooling fluid flows along the temperature sensor during the operation.

The directions stated here relate to the axial rotation axis. Thus, “axially” runs parallel or coaxially to the rotation axis. Further, the circumferential direction runs so as to surround the rotation axis or “axial”. In addition, “radial” runs transversely to the rotation axis or transversely to “axial”.

Practically, the temperature sensor is fluidically connected to the hollow space, so that the cooling fluid during the operation flows along the temperature sensor. This allows precisely and easily determining the temperature of the cooling fluid. As a consequence, an accurate feeding of the cooling fluid into the hollow space to suit requirement can be implemented, so that an increased efficiency is achieved.

The arrangement of the temperature sensor on the wall radially inside results in that with the temperature sensor the temperature of the rotor shaft can also be easily and precisely determined. This allows an improved feeding of the cooling fluid into the hollow space to suit requirement and consequently results in an increased efficiency.

In a system which besides the assembly includes an electric machine, the rotor shaft is preferentially part of a rotor of the electric machine. Besides the rotor, the electric machine includes a stator. Rotor and stator interact during the operation in such a manner that the rotor rotates about the rotation axis.

Practically, the system comprises a delivery device which during the operation delivers the cooling fluid along the flow path. The delivery device is in particular a pump or comprises a pump.

Feeding the cooling fluid into the hollow space to suit requirement preferably takes place by means of the delivery device. For this purpose, the delivery device is operated/controlled dependent on the temperature determined by means of the temperature sensor. For this purpose, the system preferably comprises a suitably configured control device. Here, the control device is communicatingly connected to the temperature sensor and the delivery device.

Preferably, an increase of the power of the delivery device and/or of the flow rate of the cooling fluid delivered by the delivery device takes place upon an increase of the temperature determined by means of the temperature sensor. Advantageously, a reduction of the power and/or of the flow rate takes place upon a decrease of the temperature determined by means of the temperature sensor.

The cooling fluid can basically be any fluid.

Advantageously, the cooling fluid is a liquid, for example oil, i.e. in particular cooling oil. This leads to an improved cooling.

The inlet opening and the outlet opening can be provided at any points of the rotor shaft.

In advantageous variants, the inlet opening is axially open.

Preferably, the inlet opening is arranged and/or formed on the first axial end face.

Embodiments, in which the rotor shaft comprises a drive plug or drive flange on the first end face are considered advantageous, wherein the inlet opening is arranged, in particular formed, in the drive plug or drive flange.

Advantageous are embodiments, in which at least one of the at least outlet openings, preferably the respective outlet opening, is axially open. Thus, an axial outflow of the cooling fluid out of the hollow space is achieved. This results in an advantageous flow of the cooling fluid within the hollow space, in particular along the wall, and thus to an increased efficiency. In addition, the cooling fluid can be more easily discharged out of the hollow space in this way.

On the second end face, the rotor shaft can comprise a bearing plug or bearing flange.

Preferably, the at least one outlet opening is radially spaced apart from the bearing plug or bearing flange. Advantageously, the at least one outlet opening is spaced apart from the bearing plug or bearing flange radially to the outside.

Embodiments, in which the temperature sensor is recessed into the wall are considered preferable. This means that the temperature sensor radially enters the wall. For this purpose, the wall can comprise for the temperature sensor an open receptacle that is open radially to the outside. This results in a simplified attachment of the temperature sensor to the wall, wherein at the same time the flow of the cooling fluid is influenced by the temperature sensor as little as possible. Thus, a simplified production with increased efficiency of the cooling is achieved at the same time.

Preferred are embodiments, in which the temperature sensor is recessed into the wall at least by two-thirds. In particular, the temperature sensor can radially end flush with the wall. This results in a further simplification of the production and a further increase of the efficiency of the cooling.

Embodiments, in which the data determined by means of the temperature sensor are transmitted wirelessly to a receiver, in particular to the control device, are considered preferred. For this purpose, the assembly comprises a corresponding communication interface. This means that the temperature sensor is connected to a communication interface in such a manner that the communication interface wirelessly transmits data determined with the temperature sensor to the receiver. This allows a simple and reliable transmission of the data determined by means of the temperature sensor.

Basically, the communication interface can basically be of any configuration.

Advantageously, the communication interface comprises a radio module or is formed as such a radio module.

In particular, the communication interface is configured in such a manner that it transmits data to the receiver via Bluetooth.

The assembly can comprise a battery for the electrical supply of the temperature sensor. For this purpose, the battery is connected to the temperature sensor. Thus, an independent and/or reliable operation of the temperature sensor is possible.

Advantageously, the battery is rechargeable. Preferably, the battery is charged during the operation of the electric machine and/or of the system.

In advantageous embodiments, the battery is attached to the rotor shaft and, for the electrical supply of the temperature sensor, connected to the temperature sensor. Preferably, the battery is arranged on the wall, in particular received in the wall.

The assembly can comprise a rectifier, which during the operation converts an alternating voltage into a rectified voltage for the electrical supply of the temperature sensor. Thus, for example an alternating voltage that is present in the system or in the electric machine can electrically supply the temperature sensor via the rectifier.

Here, the rectifier can be directly connected to the temperature sensor. It is likewise possible that the rectifier electrically supplies the temperature sensor via the battery.

Advantageously, the rectifier is attached to the wall. In particular, the rectifier is received in the wall.

In preferred embodiments, the electrical supply of the temperature sensor takes place via a transmission device, which comprises a component attached to the rotor shaft and a stationary component. The component attached to the rotor shaft thus rotates during the operation relative to the stationary component, which in the following is referred to as counter-component for better distinction. Here, the component and the counter-component interact during the operation so that in the component electrical energy for the electrical supply of the temperature sensor is present.

The electrical supply of the communication interface can take place analogously to the electrical supply of the temperature sensor, i.e. in particular via the battery and/or the rectifier and/or the transmission device.

Preferred are embodiments, in which the component is attached to the rotor shaft radially outside, in particular to the bearing plug or to the bearing flange. This results in an improved and simplified interaction of the component with the counter-component.

The transmission device can be part of the assembly. For this purpose, the stationary counter-component is attached for example to a stationary housing of the assembly.

It is also conceivable that the transmission device also comprises parts of the electric machine or of the system. In particular, the counter-component is part of the electric machine or of the system.

Basically, the transmission device can be of any configuration.

It is conceivable that the transmission device as component and counter-component comprises a slip ring and at least one brush. The transmission device thus formed as slip ring transmission device allows a simple implementation of the transmission device. Preferably, the slip ring is the component and thus attached to the rotor shaft.

It is conceivable to configure the transmission device inductively. Thus, the transmission device comprises a coil which as component is attached to the rotor shaft. The inductive transmission device comprises as counter-component a magnet or a further coil. The coil, which acts as counter-component and is thus stationary, thus acts as primary coil which induces a voltage in the coil attached to the rotor shaft and serves as secondary coil. The alternating voltage that is thus present can be directly fed to the temperature sensor or, via the rectifier, be converted into a rectified voltage.

In the system, the electric machine can basically be of any configuration.

In particular, the electric machine can be designed as a separately excited electric machine, in which in the rotor the field is generated by a separate excitation.

A particularly synergetic variant materialises in that the transmission device is also employed for the separate excitation of the rotor.

In advantageous embodiments, a lance is guided into the hollow space through the inlet opening, in particular through the drive plug or the drive flange. The lance comprises at least one lance aperture in the hollow space that is open radially to the outside. The flow path leads through the lance and the at least one lance aperture, so that the cooling fluid is radially discharged out of the at least one lance aperture in the direction of the wall. This results in a more targeted feeding of the cooling fluid into the hollow space and in the direction of the wall. As a consequence, the necessary energy requirement for feeding the cooling fluid and the heat transfer of the cooling fluid with the wall are increased. As a consequence, an increased efficiency is achieved.

It is conceivable to form at least one of the at least one lance apertures as a nozzle or to mount a nozzle to at least one of the at least one lance apertures. The nozzle is thus shaped and arranged in such a manner that the cooling fluid is dispensed in the direction of the wall in the manner of a jet. Thus, an improved efficiency in the cooling is achieved.

Advantageously, the at least one lance aperture or the at least one nozzle is arranged axially between the inlet opening and the temperature sensor. Thus, an increased heat transfer between the cooling fluid and the wall and thus an improved cooling and a reliable determination of the temperature by means of the temperature sensor is achieved at the same time.

The electric machine of the system can be of any type. In particular, the electric machine can be an electric motor. Advantageously, the electric machine is a separately excited electric motor.

The electric machine can be employed for any purposes.

In particular it is conceivable to employ the electric machine as electric motor for driving a motor vehicle. Thus, the electric machine can also be in particular a traction motor.

The system can be employed in any applications.

In particular, the system can be employed in a motor vehicle.

In the motor vehicle, the electric machine configured as traction motor can drive the motor vehicle during the operation. In the process, the increased efficiency results in a reduced energy consumption of the electric machine and consequently an increased efficiency, in particular in an increased range of the motor vehicle.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically:

FIG. 1 shows a section through an assembly with a rotor shaft,

FIG. 2 shows the section from FIG. 1 in another exemplary embodiment,

FIG. 3 shows a greatly simplified representation in the manner of a circuit diagram of a system with the assembly,

FIG. 4 shows a greatly simplified representation in the manner of a circuit diagram of a motor vehicle with the system.

### DETAILED DESCRIPTION

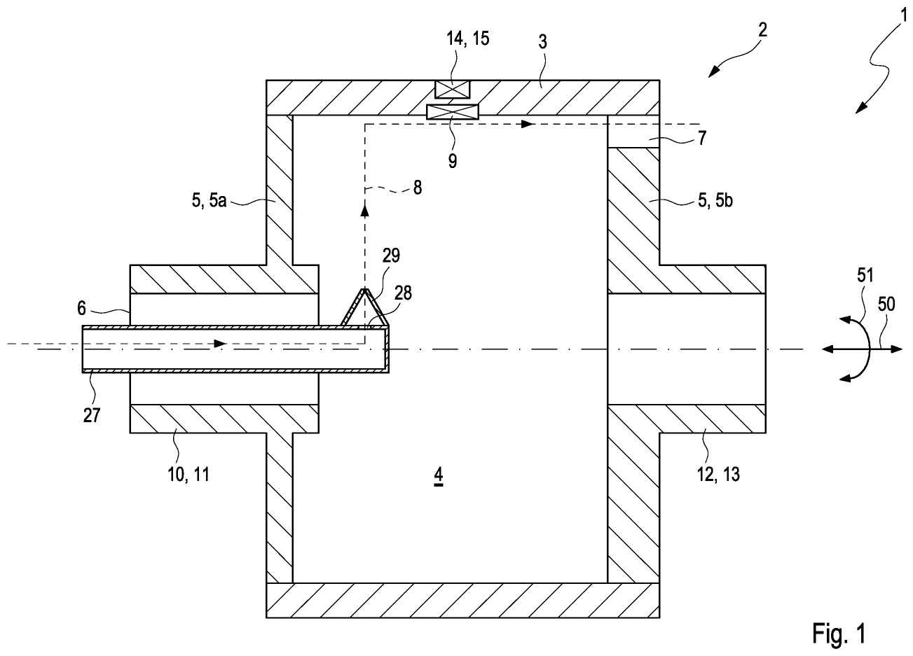

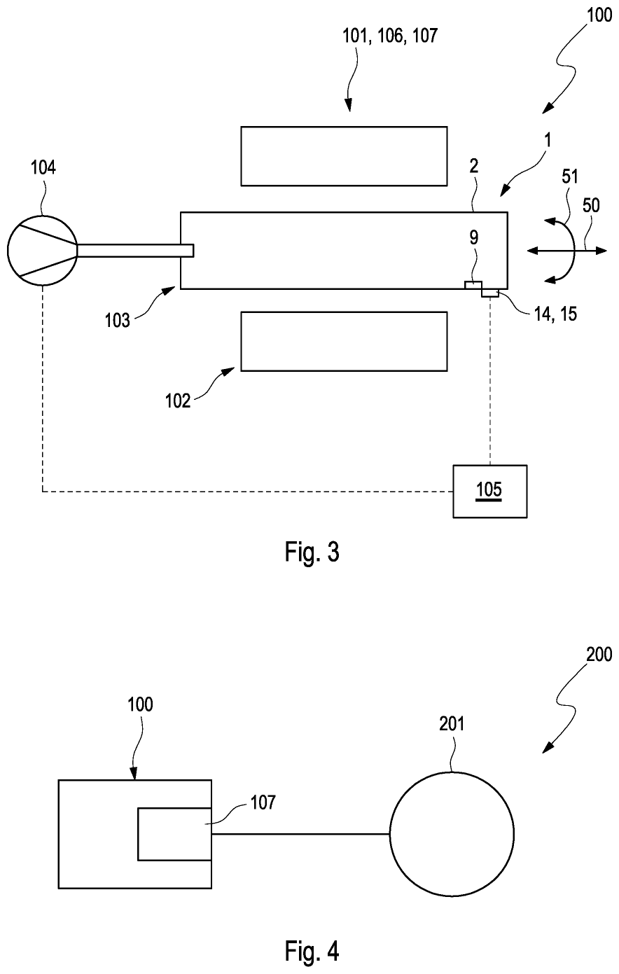

An assembly 1, as is exemplarily shown in the FIGS. 1 to 3, is employed in an electric machine 101 shown exemplarily and simplified in the FIGS. 3 and 4. The assembly 1 and the electric machine 101 are part of a system 100 shown in the FIGS. 3 and 4.

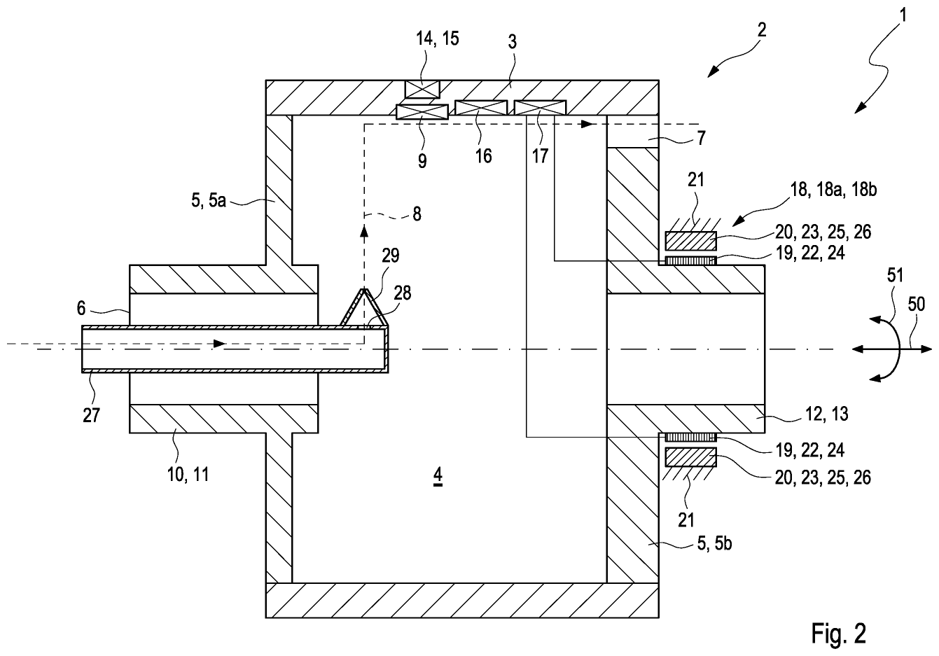

The assembly 1 comprises a rotor shaft 2 which during the operation rotates about an axial rotation axis 50. The rotor shaft 2 is formed hollow and comprises a wall 3 extending in a circumferential direction 51 and axially. The wall 3 is thus formed in the manner of a tube and radially delimits a hollow space 4 in the interior of the rotor shaft 2. Further, the rotor shaft 2 comprises two axially opposite end faces 5, namely a first axial end face 5, 5a and a second axial end face 5, 5b located opposite the first axial end face 5, 5a. For cooling the rotor shaft 2 and thus the electric machine 101, a cooling fluid, in particular a cooling liquid, for example cooling oil is conducted through the hollow space 4 during the operation. Thus, a flow path 8 of the cooling fluid leads through the hollow space 4. The rotor shaft 2 comprises an inlet opening 6 for admitting the cooling fluid into the hollow space 4 and at least one outlet opening 7 for discharging the cooling fluid out of the hollow space 4, through which the flow path 8 leads. In the FIGS. 1 and 2, a single outlet opening 7 each is more visible. In addition, the assembly 1 comprises a temperature sensor 9 which is attached to the wall 3 radially inside and along which the cooling fluid flows during the operation. Thus, the temperature of the rotor shaft 2 and/or of the cooling fluid is determined with the temperature sensor 9.

The directions indicated here relate to the axial rotation axis 50. Accordingly, “axially” runs parallel or coaxially to the rotation axis 50. Further, the circumferential direction 51 runs surrounding the rotation axis 50 or axially. In addition, “radially” runs transversely to the rotation axis 50 or transversely to axially.

In the shown exemplary embodiments, the inlet opening 6 is formed on the first end face 5, 5a and axially open. The rotor shafts 2 in the shown exemplary embodiments comprises on the first end face 5, 5a a drive plug 10 or drive flange 11 with the inlet opening 6. In the shown exemplary embodiments, the at least one outlet opening 7 is formed on the second end face 5, 5b and is axially open, so that the coolant flows axially out of the hollow space 4. In the shown exemplary embodiments, the rotor shaft 2 comprises a bearing plug 12 or bearing flange 13 on the second end face 5, 5b. The at least one outlet opening 7 is spaced apart from the bearing plug 12 or bearing flange 13 radially to the outside.

As is evident from the FIGS. 1 and 2, the temperature sensor 9 in the shown exemplary embodiments is recessed into the wall 3 by at least two-thirds. Thus, the temperature sensor 9 projects radially out of the wall 3 by a maximum of one-third into the hollow space 4. This also means that the temperature sensor 9 can end flush with the radial inside of the wall.

In order to transmit the data of the temperature sensor 9 to a receiver, the assembly 1 comprises a communication interface 14 which in the shown exemplary embodiments is a part that is separate from the temperature sensor 9, wherein the communication interface 14 could also be part of the temperature sensor 9. The communication interface 14 is configured for the wireless signal transmission, i.e. is in particular a radio module 15 or comprises such a radio module 15. With the communication interface 14 it is possible in particular to wirelessly transmit the data determined by means of the temperature sensor 9 via Bluetooth. In the shown exemplary embodiments, the communication interface 14 is purely exemplarily spaced apart from the temperature sensor 9 radially to the outside.

As is evident from the exemplary embodiment shown in FIG. 2, the assembly 1 can comprise a battery 16 which can be employed for the electrical supply of the temperature sensor 9, if required also of the communication interface 14. Accordingly, the battery 16 is connected to the temperature sensor 9, if required additionally with the communication interface 14 (not shown). In the shown exemplary embodiment, the battery 16 is received in the wall 3 of the rotor shaft 2.

According to the exemplary embodiment shown in FIG. 2, the assembly 1 can comprise a rectifier 17. During the operation, the rectifier 17 converts an existing alternating voltage into a rectified voltage for the electrical supply of the temperature sensor 9. The rectified voltage can be made available to the temperature sensor 9 for the electrical supply either directly or via the battery 16. Analogous to this, the communication interface 14 can be electrically supplied by means of the rectifier 17 if required.

As is evident from FIG. 2, a transmission device 18 can be employed for the electrical supply of the temperature sensor 9 and if required of the communication interface 14, which transmission device 18 comprises a component 19 attached to the rotor shaft 2 and a stationary component 20, wherein for better distinction the stationary component 20 is referred to as counter-component 20 in the following. Thus, the component 19 rotates relative to the counter-component 20 during the operation. The transmission device 18 is configured in such a manner that during the operation electric energy for the electrical supply of the temperature sensor 9, if required via the rectifier 17 and/or via the battery 16, is present in the component 19. Thus, the transmission device 18 can altogether be part of the assembly 1. For this purpose, the counter-component 20 can be fixedly mounted to a housing 21 of the assembly 1.

It is also conceivable that the component 19 is part of the assembly 1 and other parts of the transmission device 18, for example the counter-component 20, are part of the electric machine 101 or of the system 100. As is evident from FIG. 2, the component 19 in the shown exemplary embodiment is attached to the bearing plug 12 or the bearing flange 13 radially outside.

The transmission device 18 can be a slip ring transmission device 18, 18a, which comprises a slip ring 22 and at least one brush 23. During the operation, the at least one brush 23 slides along the slip ring 22 and thus transmits an electrical current or an electrical voltage to the slip ring 22. Thus, the slip ring 22 in the shown exemplary embodiment is the component 19, i.e. is attached to the rotor shaft 2.

Alternatively, the transmission device 18 can be an inductive transmission device 18, 18b. The inductive transmission device 18, 18b comprises a coil 24 attached to the rotor shaft 2. Accordingly, the coil 24 in this variant is the component 19. In the inductive transmission device 18, 18b, the counter-component 20 can be a magnet 25 or a coil 26. In the latter case, the coil 26 functions as a primary coil 26 which induces a voltage in the coil 24 serving as secondary coil 24. In particular in the transmission device 18 formed as inductive transmission device 18, 18b, the electrical supply of the temperature sensor 9, if required additionally of the communication interface 14, takes place via the rectifier 17 as is indicated in FIG. 2 with lines running between the coil 24 and the rectifier 17. The slip ring transmission device 18, 18a and the inductive transmission device 18, 18b are advantageous alternatives.

As is evident from the FIGS. 1 and 2, the assembly 1, in the shown exemplary embodiments, comprises a lance 27 guided through the inlet opening 6 into the hollow space 4. The lance 27 comprises at least one lance aperture 28 that is open radially to the outside, wherein in the FIGS. 1 and 2 such a lance aperture 28 is visible. During the operation, the cooling fluid is introduced via the lance 27 and the at least one lance aperture 28 into the hollow space 4 and specifically discharged in the direction of the wall 3. Thus, the flow path 8 leads through the lance 27 and the at least one lance aperture 28, so that the cooling fluid is radially discharged out of the at least one lance aperture 28 in the direction of the wall 3. In order to achieve a more specific discharge of the cooling fluid in the direction of the wall 3, a nozzle 29 is provided on the lance aperture 26 in the shown exemplary embodiments, which radially dispenses and accelerates the cooling fluid as a jet in the direction of the wall 3. The lance aperture 28 and the nozzle 29 in the shown exemplary embodiments are arranged axially between the temperature sensor 9 and the inlet opening 6. The jet of the cooling fluid axially strikes the wall 3 between the temperature sensor 9 and the inlet opening 6. Because of the rotation of the rotor shafts 2, the cooling fluid is delivered in the direction of the at least one outlet opening 7 and in the process flows along the temperature sensor 9.

With the temperature sensor 9 it is possible to introduce the cooling fluid into the hollow space 4 to suit requirement. Thus, an efficient and specific cooling with reduced energy consumption at the same time is achieved.

An associated system 100 shown in FIG. 3 greatly simplified and in the manner of a circuit diagram includes the assembly 1 and the electric machine 101.

The electric machine 101 comprises a stator 102 and a rotor 103 interacting with the stator 102 during the operation in such a manner that the rotor 103 rotates about the axial rotation axis 50. The rotor 103 comprises the rotor shaft 2. The system 100, further, includes a delivery device 104, which delivers the cooling fluid during the operation. In addition, the system 100 comprises a control device 105 which is communicatingly connected to the temperature sensor 9 and the delivery device 104. The control device 105 is the receiver mentioned above, which wirelessly receives the data transmitted via the communication interface 14. Further, the control device 105 is configured in such a manner that it controls the delivery device 104 dependent on the temperature determined by means of the temperature sensor 9. For this purpose, the power of the delivery device 104 and/or of the flow rate of the cooling fluid delivered with the delivery device 104 is changed dependent on the determined temperature. In particular, the power and/or the flow rate are/is increased with increasing temperature and/or reduced with decreasing temperature.

In the exemplary embodiments shown in the FIGS. 3 and 4, the electric machine 101 is configured as a separately excited electric machine 106 and as traction motor 107. Here, the transmission device 18 is employed for the separate excitation of the rotor 103 at the same time.

As is shown in FIG. 4 greatly simplified and in the manner of a circuit diagram, the system 100 can be employed in a motor vehicle 200. Thus, the electric machine 101 configured as traction motor 107 serves for driving the motor vehicle 200. For this purpose, the traction motor 107, as indicated in FIG. 4, is drive-connected or can be drive-connected to at least one wheel 201 of the motor vehicle 200. The increased efficiency of the cooling and thus of the traction motor 107 result in an increased range of the motor vehicle 200.

1. An assembly for an electric machine, comprising:
a rotor shaft that rotates about an axial rotation axis, the rotor shaft includes a wall extending in a circumferential direction, and in an interior of the rotor shaft, the wall radially delimits a hollow space; and
a temperature sensor attached radially inside the wall;
wherein the rotor shaft further includes a first axial end face, a second axial end face located opposite the first axial end face, an inlet opening for admitting a cooling fluid into the hollow space, and at least one outlet opening for discharging the cooling fluid out of the hollow space; and
the cooling fluid flows along the temperature sensor.

2. The assembly according to claim 1, wherein the temperature sensor is recessed into the wall.

3. The assembly according to claim 1, wherein the temperature sensor is connected to a communication interface such that the communication interface wirelessly transmits data, determined with the temperature sensor, to a receiver.

4. The assembly according to claim 1, wherein the assembly further includes a battery attached to the rotor shaft and electrically connected to the temperature sensor, the battery is configured for electrical supply of the temperature sensor.

5. The assembly according to claim 4, wherein the assembly further includes a rectifier that converts an alternating voltage into a rectified voltage for the electrical supply of the temperature sensor.

6. The assembly according to claim 5, wherein a component of a transmission device is attached to the rotor shaft, the component interacts with a stationary counter-component of the transmission device such that in the component, electric energy for the electrical supply of the temperature sensor is present.

7. The assembly according to claim 6, wherein the transmission device is formed as a slip ring transmission device that includes a slip ring and a brush; and
the component is the slip ring or the brush.

8. The assembly according to claim 6, wherein the transmission device is an inductive transmission device and the component is a coil of the inductive transmission device.

9. The assembly according to claim 1, wherein:
the inlet opening is formed on the first axial end face;
a lance is guided through the inlet opening into the hollow space, the lance includes at least one lance aperture in the hollow space that is open radially outside; and
a flow path of the cooling fluid leads through the lance at the lance aperture such that the cooling fluid is radially discharged out of the lance aperture in a direction of the wall.

10. A system, comprising:
an electric machine including a stator and a rotor, the rotor rotates about the axial rotation axis, and the rotor includes the rotor shaft; and
an assembly according to claim 1.

11. The system according to claim 10, including a delivery device that delivers the cooling fluid;
wherein the system further includes a control device that is communicatingly connected to the temperature sensor and the delivery device; and
the control device is configured to control the delivery device dependent on a temperature determined by the temperature sensor.

12. The system according to claim 10, wherein the electric machine is formed as a separately excited electric machine.

13. The system according to claim 12, wherein a transmission device is simultaneously employed for the separate excitation of the rotor.

14. The system according to claim 10, wherein the electric machine is formed as a traction motor.

15. A motor vehicle, comprising:
a system according to claim 10.

16. The assembly of claim 1, wherein the temperature sensor is recessed into the wall by at least two-thirds.

17. An assembly, comprising:
a rotor shaft including a wall defining a hollow space; and
a temperature sensor attached to the wall;
wherein the rotor shaft further includes a first axial end face, a second axial end face located opposite the first axial end face, an inlet opening for admitting a cooling fluid into the hollow space, and at least one outlet opening for discharging the cooling fluid out of the hollow space.

18. The assembly according to claim 17, wherein the temperature sensor is recessed into the wall.

19. The assembly according to claim 17, wherein the temperature sensor is connected to a communication interface such that the communication interface wirelessly transmits data, determined with the temperature sensor, to a receiver.

20. The assembly according to claim 17, wherein the assembly further includes a battery attached to the rotor shaft and electrically connected to the temperature sensor, the battery is configured for electrical supply of the temperature sensor.
